(19) United States
(12) Patent Application Publication
(10) Pub. No.: US 2010/0272847 A1
(43) Pub. Date: Oct. 28, 2010

(54) Device for Production of Layer of Nanofibres through Electrostatic Spinning of Polymer Matrices and Collecting Electrode for Such Device

(76) Inventors: Ladislav Mares, Liberec (CZ); David Petras, Zlin (CZ)

Correspondence Address: OSTROLENK FABER GERB & SOFFEN, 1180 AVENUE OF THE AMERICAS, NEW YORK, NY, 100368403, US

(21) Appl. No.: 12/738,416

(22) PCT Filed: Oct. 15, 2008
(86) PCT No.: PCT/CZ2008/000125

§ 371 Date: Jul. 15, 2010

(30) Foreign Application Priority Data
Oct. 18, 2007 (CZ) PV 2007-729

(51) Int. Cl. B29C 47/00

(52) U.S. Cl. 425/505

(57) ABSTRACT

The invention relates to the device for production of nanofibres through electrostatic spinning of polymer matrices in electrostatic field of high intensity induced through difference of potentials between the spinning electrode (3) and the collecting electrode (4), which comprises the cylindric body (41), while the nanofibres are deposited on the substrate material (5) conducted between the spinning electrode (3) and collecting electrode (4). The cylindric body (41) of collecting electrode is mounted rotatably coincidentally to direction of motion of substrate material (5). The cylindric body (41) may be provided with the tips (416).

### TECHNICAL FIELD

The invention relates to the device for production of nanofibres through electrostatic spinning of polymer matrices in electrostatic field of high intensity induced through difference of potentials between the spinning electrode and the collecting electrode, which comprises a cylindric body, while the nanofibres are deposited on substrate material conducted between the spinning electrode and the collecting electrode.

Next to this the invention relates to the collecting electrode of the device for production of nanofibres through electrostatic spinning of polymer matrices, which comprises the cylindric body.

### BACKGROUND ART

The device for production of layer of nanofibres through electrostatic spinning of polymer matrices comprises the spinning electrode and the collecting electrode, which is usually formed of a rod or a metal plate connected to the opposite pole of high voltage source than the spinning electrode or is grounded.

In CZ 294 274 are, next to others, described also cylindric rod-shaped collecting electrodes, which are towards the spinning electrode positioned behind the substrate material, which does not touch their surface. Electric field is induced between the cylindric spinning electrode and individual rods forming the collecting electrode. The resultant electric field is not homogenous and it may be unstable in time. During the process and on the nanofibrous layer is this reflected especially by drop of production and by increase in non-uniformity of performance.

Further is from CZ PV 2006-477 known the collecting electrode which comprises a conductive thin-walled body of electrode, in whose face is performed at least one opening, around whose perimeter is arranged the border, while in the inner space of electrode body there is mounted at least one holder of electrode interconnected with at least one brace fastened in the spinning chamber, while the holder of electrode is arranged behind the opening border and it is electrically non-conducting. This embodiment of collecting electrode does not produce any corona and field induced through the collecting electrode is influenced only by shape of the collecting electrode. At this embodiment of the collecting electrode, elimination or compensation of the electric charge applied by means of nanofibres to the substrate seems to be problematic.

Therefore the device for production of nanofibres through electrostatic spinning was further improved according to CZ PUV 2007-18612, by which is the collecting electrode in contact with substrate material. Electric charge brought to substrate material by nanofibres is due to contact of substrate material with conductive body of the collecting electrode of cylindric shape carried away from substrate material, nevertheless the disadvantage of this solution is an increased friction of substrate material on the surface of the collecting electrode, when especially in the case of fine substrate materials consisting of weakly mutually fixed fibres, e.g. the fine web, the damage of substrate material occurs or may occur, especially when the device comprises more spinning units and thus also more collecting electrodes and substrate material must be strongly stretched.

The goal of the invention is to reduce or totally eliminate the disadvantages of background art.

### PRINCIPLE OF THE INVENTION

The goal of the invention has been reached by the device for production of nanofibres through electrostatic spinning of polymer matrices according to the invention, whose principle consists in that the cylindric body of collecting electrode is mounted rotatably coincidentally with direction of motion of substrate material, through which is the resistance developed by the collecting electrode against motion of substrate material reduced and the substrate material is subjected to lower stress. As a result of this, wear of the collecting electrode and especially danger that the substrate material is damaged, is reduced.

To improve sticking of substrate material on surface of the cylindric body of collecting electrode it is advantageous, if the cylindric body is provided with a cavity connected to source of underpressure and in peripheral casing of cylindric body are performed openings for air suction, through which is the substrate material simultaneously sucked to surface of cylindric body of the collecting electrode.

To improve transport of substrate material formed especially of fine web of relatively great thickness it is advantageous, if the cylindric body of collecting electrode is provided with tips on its perimeter, that are able to extend into the substrate material and to exit from it and thus exactly determine the speed of motion of substrate material, its position and also its stretching between the collecting electrodes of individual, one after another, arranged spinning units.

For improving of spinning effect it is advantageous, if the tips are made of electrically conductive material and their length corresponds to thickness of substrate material.

At sufficient density of tips of electrically conductive material it is advantageous, if these tips are mounted in body of electrically non-conducting material and at least in position against the spinning electrode the tips are connected to the high voltage source of opposite polarity than the spinning electrode or grounded. Electrostatic field in this case is induced between the tips and the spinning electrode. The produced nanofibres are carried from the spinning electrode towards the tips of collecting electrode and they deposit on substrate material.

In embodiment according to the claim 6 the tips are made of electrically non-conducting material and they are mounted in the cylindric body from electrically conductive material, which is connected to high voltage source of opposite polarity than the spinning electrode or grounded. This embodiment is suitable for substrate materials formed of thin webs of electrically conductive material or of material, at which the electric conductivity was increased by some of the known methods. At such thin webs it is sufficient, when the electrostatic field is induced between the spinning electrode and cylindric surface of collecting electrode, with which is the web in contact.

If the device contains collecting electrode, whose cylindric body is made of electrically conductive material, it is according to the claim 7 advantageous, if the cylindric body of the collecting electrode contains the conductive thin-walled body, in whose at least one face is performed the opening, around whose perimeter is arranged the border. Through opening in the face there passes the brace, which is fastened in the spinning chamber. On the brace is in inner space of conductive thin-walled body, in rotatable manner mounted the holder of electrode, which is fixed in conductive thin-walled body. The collecting electrode according to this embodiment minimises possibilities for creating of corona, especially on edge (face) parts of the cylindric body. In the case when is the collecting electrode provided in this way with conductive tips on its perimeter, the device according to the invention is able to deposit the nanofibres on substrate materials formed of webs of greater thickness.

The principle of collecting electrode according to the invention consists in that the cylindric body of collecting electrode is provided with means for its rotatable mounting in the spinning chamber of the device for production of nanofibres through spinning of polymer matrices. Rotatable mounting of the collecting electrode enhances possibilities for usage of fine substrate materials, which are formed of fabrics of low linear bonding strength (consistence), e.g. of the webs.

In advantageous embodiment according to the claim 9 the cylindric body of the collecting electrode is hollow and in its inner space the holder is fixed, which is rotatably mounted on the brace, which protrudes from the inner space of cylindric body through at least one face of cylindric body and it is provided with means for mounting in the spinning chamber.

At the same time it is advantageous, if in the peripheral casing of cylindric body of the collecting electrode the openings for suction of air are performed and the cavity of cylindric body is connectable to underpressure source. By action of underpressure the collecting electrode is able to act on the substrate material, which touches it during the spinning process, and to keep it on its surface.

Embodiment of rotatable collecting electrodes with smooth casing is further improved according to the claim 11 by that it is provided on its surface with tips which may be of electrically conductive material or may be of electrically non-conducting material on condition that they are mounted in cylindric body of electrically conductive material. The tips of electrically conductive material may be mounted in a body of conductive material or in a body of non-conducting material. Selection of materials for the tips and material for the cylindric body depends on technological conditions of spinning, on the polymer matrix subjected to spinning and on other factors according to application of the produced nanofibres, etc.

### DESCRIPTION OF THE DRAWING

Exemplary embodiment of the device according to the invention and the collecting electrode according to the invention is schematically represented on enclosed drawings, where

FIG. 1 shows the spinning device with collecting electrode containing the rotatably mounted smooth cylinder,

FIG. 2 cylindric body of collecting electrode provided with openings in casing and cavity inside,

FIG. 3 another variant of the device at which the cylindric body of collecting electrode is provided with tips,

FIG. 4 shows cylindric body of collecting electrode with casing of electrically conductive material, in which the tips of electrically non-conducting material are attached,

FIG. 5 cylindric body of collecting electrode with casing of electrically non-conducting material, in which the tips of electrically conductive material are attached,

FIG. 6 cylindric body of the collecting electrode formed of conductive thin-walled body preventing creation of corona.

### EXAMPLES OF EMBODIMENT

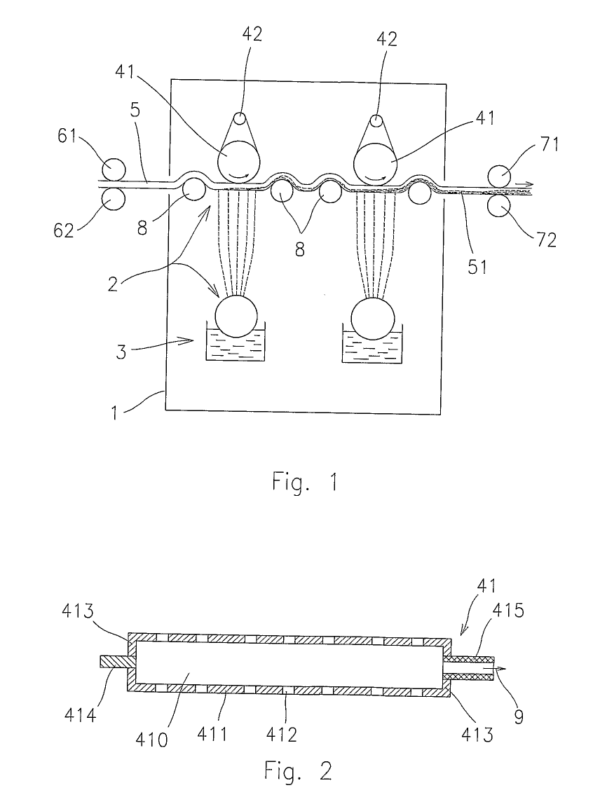

Exemplary embodiment of the device for production of nanofibres through electrostatic spinning of polymer matrices in electrostatic field of high intensity according to the invention is represented in FIG. 1. Polymer matrix is formed of any electrostatic spinnable form of polymer possibly with various additives or mixture of polymers, that may also be added with various additives, while usually the electrostatic spinnable form is solution or melt. In the spinning chamber 1 there are arranged two spinning units 2, out of which each comprises the spinning electrode 3 and against it arranged collecting electrode 4. Between the spinning electrode 3 and collecting electrode 4 electrostatic field of high intensity is induced in a known manner. In the spinning chamber 1 in a known manner, not described in detail, is created the passage for substrate material 5, which is unwound in the known not represented unwinding device and is brought into the spinning chamber 1 by feeding rollers 61, 62. From the spinning chamber 1 the substrate material 5 is taken away by the draw-off rollers 71, 72, behind which it is in a known not represented manner wound in the not represented winding device. The spinning electrode 3 may be created in any known manner, while in the represented example of embodiment is represented the rotating spinning electrode formed of rotating cylindric body, whose surface section extends into reservoir with polymer matrix being subjected to spinning.

The collecting electrode 4 contains the cylindric body 41 of electrically conductive material, which is in the spinning chamber 1 in a known manner, not represented in detail, mounted rotatably coincidentally to direction of motion of the substrate material 5. The cylindric body 41 of collecting electrode is in a known not represented manner connected to the high voltage source of opposite polarity than the spinning electrode 3 or is grounded. In embodiment represented in FIG. 1 the cylindric body 41 of collecting electrode is coupled with the drive 42, which ensures its forced rotation in direction corresponding to the direction of motion of the substrate material 5, while the rotation speed in some of the known manners is regulated according to the speed of motion of the substrate material 5. The substrate material 5 is led tangential to perimeter of the cylindric body 41 of collecting electrode, while embracement of substrate material 5 around circumference of cylindric body 41 of the collecting electrode may be increased by the guiding means 8, which are in direction of motion of substrate material 5 mounted before and after the cylindric body 41 of collecting electrode, as it is shown in FIG. 1. The guiding means 8 may be sliding ones, made of a suitable shaped body of smooth, abrasion-resistant material or rotating ones, formed of rotatably mounted cylindric bodies. The guiding means are arranged in sufficient distance from the collecting electrode 4, so that they do not influence electrostatic field between the spinning electrode 3 and collecting electrode 4.

During the spinning process the substrate material 5 moves through the spinning chamber 1 between the spinning electrode 3 and collecting electrode 4, while it is in contact with surface of the cylindric body 41 of collecting electrode. The cylindric body 41 of collecting electrode rotates in direction and in a speed corresponding to direction and speed of motion of substrate material, by which is the resistance developed by stationary collecting electrode 4 against motion of substrate material 5 eliminated and the substrate material 5 is less stressed. Rotatably mounted cylindric collecting electrode is suitable especially for the fine substrate materials, by which it reduces the danger of damage of substrate material through abrasion against surface of the collecting electrode 4.

For more resistant substrate materials may be used the cylindric body 41 of collecting electrode which is mounted in the spinning chamber 1 freely rotatably without forced drive. Rotation of the cylindric body 41 of collecting electrode is after then secured by friction from motion of substrate material 5.

To improve contact of the substrate material 5 with surface of the cylindric body 41 of collecting electrode, the embodiment according to FIG. 2 is advantageous, at which the cylindric body 41 of collecting electrode is provided with the cavity 410 and in the casing 411 the openings 412 connecting the cavity 410 with outer space are performed. In the faces 413 of the cylindric body 41 of collecting electrode the journals 414, 415 are mounted for rotatable mounting of the cylindric body 41 of collecting electrode in the spinning chamber 1. At least one journal 415 is hollow, as it is at the represented embodiment, and by some of the known methods connectable to source of low air pressure, which is in FIG. 2 illustrated by the arrow 9 and which serves to suck off the air from the cavity 410 of cylindric body of the collecting electrode. Due to this, through the openings 412 in casing 411 of the cylindric body of collecting electrode the air or other gaseous medium is sucked in from the space of the spinning chamber 1 and substrate material 5 is sucked to a portion of the surface of the cylindric body 41 of the collecting electrode, around which it passes.

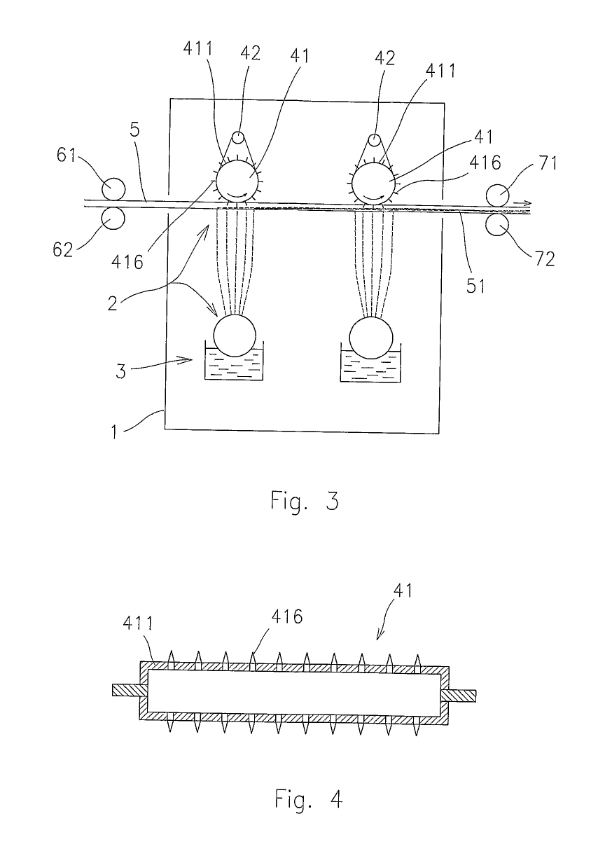

In embodiment according to FIG. 3 the cylindric body 41 of collecting electrode is provided with tips 416 on circumference of its casing 411. Embodiment of the tips 416 and casing 411 of the cylindric body of collecting electrode may be at the same time various according to the technological conditions of spinning, according to the type of the polymer matrix subjected to spinning, according to application of the produced nanofibrous layer, etc. The tips 416 are designated especially to improve transport of substrate material 5 formed especially of fine webs of a low linear bonding strength at relatively high thickness. When the substrate material 5 passes around the collecting electrode 4 the tips 416 extend into the substrate material 5, they penetrate it at least partially and subsequently they exit from the substrate material again. By this the tips 416 exactly determine the speed of motion of substrate material 5, its position and stretching of substrate material between the collecting electrodes 4 of individual one after another arranged spinning units 2.

In embodiment according to FIG. 3 the cylindric body 41 of collecting electrode is made of electrically conductive material as well as the tips 416. Length of the tips 416 corresponds to thickness of substrate material 5. At low concentration of the tips 416 arranged in the casing 411 of cylindric body of collecting electrode the electrostatic field between the spinning electrode 3 and collecting electrode 4 is induced between the active section of the spinning electrode 3 and against it positioned section of circumference of the casing 411 of the spinning electrode, while in the place of the tips 416 the electrostatic field is induced between the active section of the spinning electrode 3 and against it positioned tip 416. On the top of electrically conductive tip 416 is the brought charge concentrated into a point singular charge, which contributes to producing of nanofibres, especially in initial phase of the spinning process. The produced nanofibres are deposited on surface of substrate material 5. At high concentration of the tips 416 arranged in the casing 411 of the cylindric body of the collecting electrode electrostatic field is induced between the active section of the spinning electrode 3 and the tips 416 arranged in the given moment against this active section of the spinning electrode 3. At this embodiment the tops of tips 416 form the grid of singular charges. The produced nanofibres are deposited on surface of the substrate material 5.

According to FIG. 4 are in the cylindric body 41 of collecting electrode made of electrically conductive material attached the tips 416 of electrically non-conducting material. In case of installation of such collecting electrode 4 into the spinning unit 2 of the device according to the invention, the electrostatic field is induced between the active section of the spinning electrode 3 and against it positioned section of the casing 411 of the cylindric body of collecting electrode, while the tips 416 exert only function of transportation and maintaining of position of the substrate material 5.

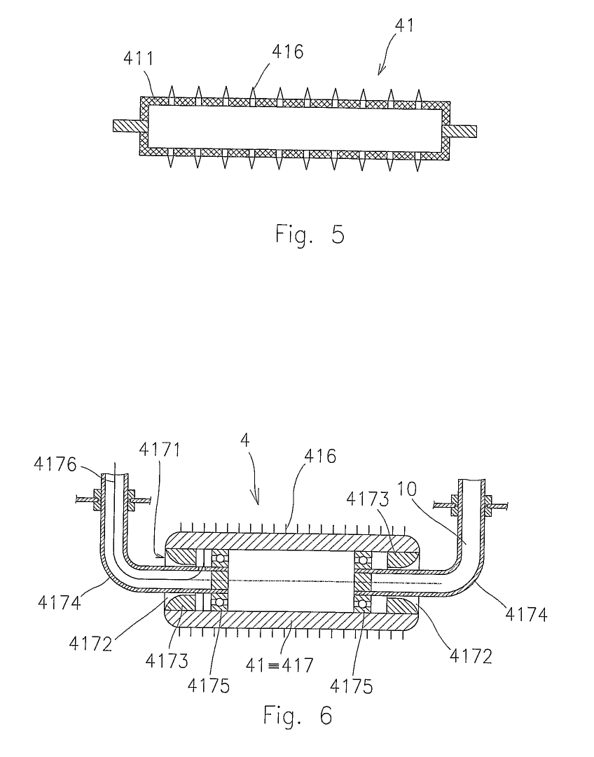

Another exemplary embodiment of cylindric body 41 of collecting electrode is represented in FIG. 5. At this embodiment the cylindric body 41 is made of electrically non-conducting material and in it are mounted the tips 416 of electrically conductive material, while the tips 416 are connected to the high voltage source of opposite polarity than the spinning electrode 3 or grounded. At rotation of the collecting electrode 4 and motion of the substrate material 5 the tips 416 enter into the substrate material and electrostatic field is induced between the active section of spinning electrode 3 and against it positioned tops of tips 416. The produced nanofibres 30 are carried from the spinning electrode 3 towards the tops of tips 416 of collecting electrode and they deposit on substrate material 5. At this embodiment it is advantageous, if at least the tips 416 whose tops are just to be found against the spinning electrode 3 are connected to the source of high voltage.

At example of embodiment according to FIG. 6 the cylindric body 41 of collecting electrode contains conductive thin-walled body 417, in whose at least one face 4171 there is performed opening 4172, around whose perimeter is arranged the border 4173. Through the face 4171 the brace 4174 is passing, which is attached in the spinning chamber 1. On the brace 4174 in the inner space of the conductive thin-walled body 417 is rotatably mounted the holder 4175 of collecting electrode, which is fixed in the conductive thin-walled body 417. The conductive thin-walled body 417 may be provided with tips 416 of conductive or non-conducting material.

All embodiments of the cylindric body 41 of collecting electrode equipped with tips 416 may be provided with openings 412 in the casing 411, while the openings 412 are performed between the tips 416 and serve to stick the substrate material 5 to the casing 411 of the collecting electrode cylindric body.

### LIST OF REFERENTIAL MARKINGS

1 spinning chamber
2 spinning unit
3 spinning electrode
4 collecting electrode
41 cylindric body of collecting electrode
410 cavity
411 casing
412 openings
413 faces
414, 415 journals
416 tips
417 conductive thin-walled body
4171 face of conductive thin-walled body
4172 opening
4173 border
4174 brace
4175 holder
42 drive
5 substrate material
61, 62 feeding rollers
71, 72 draw-off rollers
8 guiding means of substrate material
9 arrow showing the source of low air pressure

1. The device for production of nanofibres through electrostatic spinning of polymer matrices in electrostatic field of high intensity induced through difference of potentials between the spinning electrode and the collecting electrode, which comprises the cylindric body, while the nanofibres are deposited on the substrate material conducted between the spinning electrode and collecting electrode, characterized in that the cylindric body (41) of collecting electrode is mounted rotatably coincidentally to direction of motion of substrate material (5).

2.-14. (canceled)
